(19) United States
(12) Patent Application Publication
(10) Pub. No.: US 2005/0014873 A1
(43) Pub. Date: Jan. 20, 2005

(54) Phosphorus-containing compound for use as flame retardant and flame retardant resin

(75) Inventors: Ying-Ling Liu, Taoyuan (TW); Yie-Chan Chiu, Taoyuan (TW)

Correspondence Address: BACON & THOMAS, PLLC, 625 SLATERS LANE, FOURTH FLOOR, ALEXANDRIA, VA, 22314, US

(73) Assignee: CHUNG YUAN CHRISTIAN UNIVERSITY, Taoyuan (TW)

(21) Appl. No.: 10/621,519

(22) Filed: Jul. 18, 2003

(51) Int. Cl. C09K 21/00; C08K 5/34; C08K 5/49

(52) U.S. Cl. 524/104; 252/609; 524/116

(57) ABSTRACT

A phosphorus containing compound having the following structure is disclosed, which can be blended a resin or reacted with a compound to form a flame retardant resin: 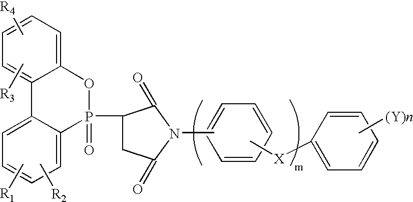
wherein R₁-R₄ independently are H or C₁-C₄ alkyl; X is a single bond, —CH₂—, —C(CH₃)₂—, 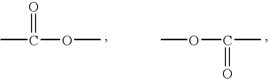
—O—, —S—, —SO₂—; Y is H, C₁-C₄ alkyl, —OH, —NH₂, —NO₂, —COOH, —CHO, or 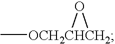 m is integer of 0-2; and n is an integer of 1-4.

### FIELD OF THE INVENTION

The present invention relates to a phosphorus-containing compound, which can be blended with another resin or polymerized with a monomer to prepare a flame retardant resin.

### BACKGROUND OF THE INVENTION

Besides conventional building materials and textiles, a polymeric material is required to have flame retardance when used in the fabrication of an electronic device, e.g. a printed circuit board, encapsulation resin of an integrated circuit (IC), and electronic connectors, etc. In order to increase the flame retardance of an polymeric material, an addition of a flame retardant is used to achieve this objective regardless of whether the polymer is a thermoset resin or a thermoplastic resin. Organic phosphorus compounds have been widely used as a halogen-free flame retardant to improve or solve the problems such as the formation of toxic fume, corrosion, contamination of dioxin, etc. associated with the use of a halogen-containing flame retardant. Among which, phosphates including aliphatic or aromatic phosphates are widely used in the current products, e.g. triphenylphosphate, tricresylphosphate, and triethylphosphate, etc. These phosphates, after being added into a resin, may cause defects such as insufficient thermal stability and undesired high migration, etc. Therefore, some phosphate oligomers, such as resorcinol diphenyldiphosphate and its oligomer (e.g. Japan Patent 223158, U.S. Pat. No. 5,204,394, and U.S. Pat. No. 5,618,867), phosphate oligomers having a substituent (e.g. U.S. Pat. No. 5,506,313, EP-A-0456605, and EP-A-0509506), etc. were developed as a halogen-free flame retardant. However, the phosphates oligomers inherently suffer insufficient thermal stability in comparison with the conventional bromine-containing flame retardants due to P—O bonding. In order to meet the high processing temperature requirement of newly developed fabrication processes of electronic devices such as surface mounting technology (SMT), and compounding and extruding of engineering plastics, flame retardants free of phosphorus such as derivatives of melamine compounds and silicon-containing compounds have been developed, e.g. U.S. Pat. Nos. 5,703,258 and 6,034,146. However, the flame retardance of these compounds is still not satisfactory. Another approach as disclosed in U.S. Pat. Nos. 6,291,627 and 6,441,067 is using cyclic phosphorus-containing compounds as a flame retardant.

### SUMMARY OF THE INVENTION

One objective of the present invention is to provide a phosphorous-containing compound with a novel chemical structure.

Another objective of the present invention is to provide a novel phosphorous-containing compound as a flame retardant.

Another objective of the present invention is to provide a flame retardant resinous composition by blending, as a flame retardant, a phosphorous-containing compound of the present invention with another resin, or copolymerizing a phosphorous-containing compound of the present invention and a monomer.

Another objective of the present invention is to provide a cured flame retardant resin which is prepared by cross-linking a flame retardant resinous composition of the present invention.

In order to achieve the above-mentioned objectives of the present invention, a phosphorous-containing compound synthesized according to the present invention has a maleimide group which can create a synergistic flame retardance with the phosphorus element. In one of the preferred embodiments of the present invention, the phosphorous-containing compound synthesized according to the present invention has a thermal stability at a temperature higher than 300° C.

### DETAILED DESCRIPTION OF THE INVENTION

The present invention discloses a novel phosphorous-containing compound for use as a flame retardant in various organic macromolecular materials, which has the following structure: 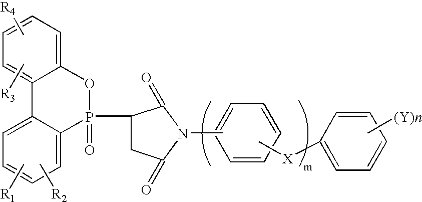
wherein R₁-R₄ independently are H, or C₁-C₄ alkyl; X is a single bond, —CH₂—, —C(CH₃)₂—, 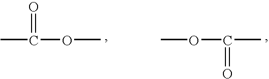
—O—, —S— or —SO₂—; Y is H, C₁-C₄ alkyl, —OH, —NH₂, —NO₂, —COOH, —CHO or 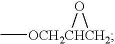
m is an integer of 0-2, and n is an integer of 1-4.

Preferably, Y is H.

Preferably, Y is —OH.

Preferably, Y is —COOH.

Preferably, Y is

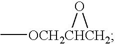

Preferably, R₁-R₄ are H.

Preferably, X is a single bond.

Preferably, X is —CH₂—.

Preferably, X is —C(CH₃)₂—.

Preferably, m is 0.

Preferable examples of the compounds of the present invention are A, B, C and D synthesized in the following Examples 1-3.

A suitable process for preparing the phosphorus-containing compound of the present invention comprises reacting a substituted or non-substituted 9, 10-dihydro-9-oxa-10-phosphaphenanthrene 10-oxide (abbreviated as DOPO) having the following structure: 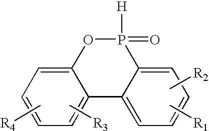
(wherein R₁-R₄ are defined as above) with an maleimide having the following structure: 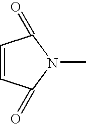
at a temperature of 30-200° C. Various derivatives can be prepared from the resulting compound from the abovementioned reaction by using the conventional organic synthesis methods.

The phosphorous-containing compound of the present invention can be easily synthesized, and can be used to prepare a flame retardant resin having a high phosphorous content and a high thermal stability, so as to improve the defects of a complicated synthesis procedures, a lower phosphorous content, and an insufficient thermal resistance, etc. existing in the conventional phosphorous-containing flame retardants. In one aspect of the present invention, the phosphorus-containing compound does not have reactive group and is used as an additive type flame retardant for various types of organic polymeric material. In another aspect of the present invention, the phosphorus-containing compound has a reactive group and is used as a reactive type flame retardant, which can react with a target compound or resin to form various types of organic polymeric material with flame retardance.

The present invention can be further understood with the following examples which are used for illustrative purposes and not for limiting the scope of the present invention. The reactions involved in the following examples are shown in the following scheme:

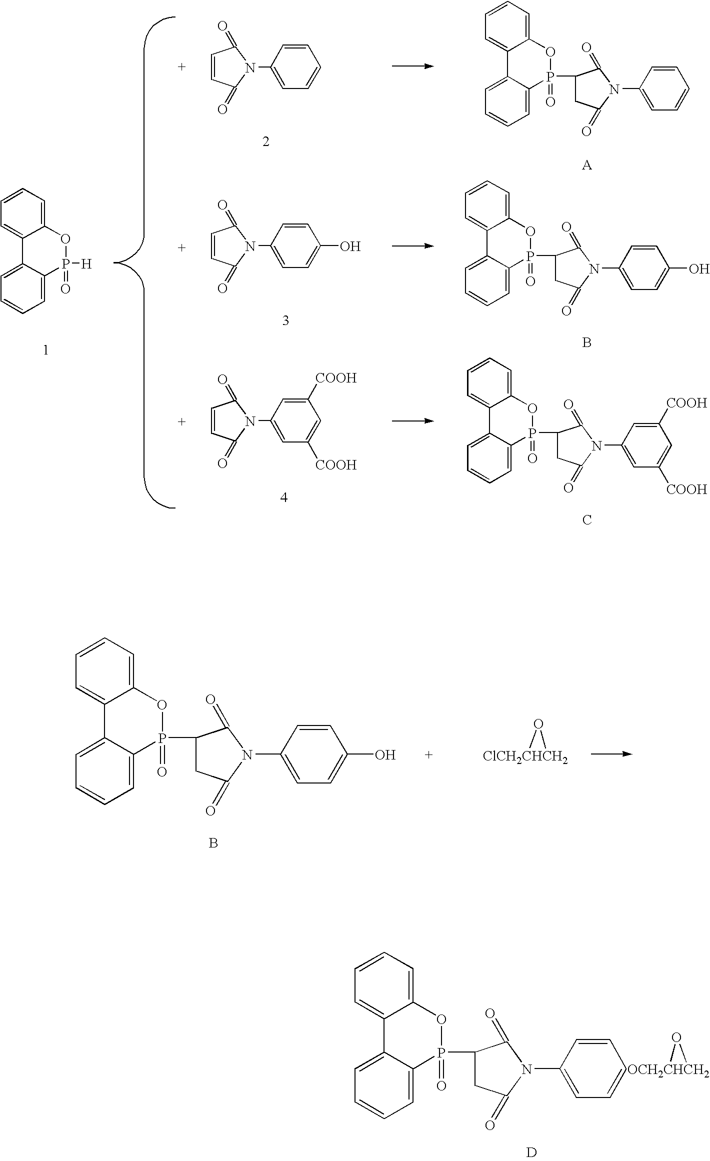

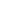

### EXAMPLE 1

### (Synthesis of Compound A)

To a 1 L three-necked flask equipped with a temperature control and indication device, 512 g of DOPO (compound 1) and 107 g of N-phenyl maleimide (compound 2) were added. The reaction mixture was heated and maintained at 180° C. for three hours, and then 500 ml of toluene was added. After agitation, the mixture was filtered. The resulting solid was washed with 500 ml of toluene twice, filtered and dried under vacuum at 80° C. for two hours to yield a white solid product, a DOPO derivative compound A (120 g).

### EXAMPLE 2

### (Synthesis of Compound B)

The procedures in Example 1 were repeated except that phenyl maleimide was replaced by 4-maleimidophenol (compound 3). A lemon yellow solid product having a OH group, a DOPO derivative compound B, was obtained (144 g).

### EXAMPLE 3

### (Synthesis of Compound C)

The procedures in Example 1 were repeated except that phenyl maleimide was replaced by 3-maleimido-1,5-benzoic diacid (compound 4). A lemon yellow solid product having a OH group, a DOPO derivative compound C, was obtained (135 g).

### EXAMPLE 4

### (Synthesis of Compound D)

To a 3L four-necked flask equipped with a temperature and pressure control and indication device, 100 g of a DOPO derivative compound B and 400 g of epichlorohydrin were added. The flask was also equipped with a device capable of condensing and separating an azeotropic mixture of water and epichlorohydrin into an oil phase and an aqueous phase. The reaction mixture was agitated to become a homogeneous solution under atmospheric pressure, and was then heated to 70° C. under an absolute pressure of 190 mmHg. At an equilibrium temperature and pressure of this solution, 80.2 g of 49.3% sodium hydroxide solution was added to the solution with a constant rate within four hours. While the sodium hydroxide solution was being added, water in the reaction system was removed by an azeotropic distillation. The azeotrope, after condensation, was separated into an oil phase and an aqueous phase. The oil phase was continuously recycled to the reaction system, and the aqueous phase was removed. After completion of the reaction, the unreacted epichlorohydrin and solvent were removed by distillation under a reduced pressure. The crude epoxy resin thus formed was dissolved by methyl ethyl ketone, mixed with deionized water to wash away sodium chloride in the resin. The dissolved epoxy solution was subsequently distilled under a reduced pressure to remove the methyl ethyl ketone thereby obtaining a lemon yellow epoxy-containing DOPO derivative D (108 g).

### EXAMPLE 5

### (Preparation of Flame Retardant Resins)

Phosphorus-containing flame retardant epoxy resins were prepared by blending compound D with a commercially available epoxy resin of diglycidyl ether of bisphenol A (Chang Chun Plastics Co., Ltd., Taiwan, Code BE 188) in various ratios listed in the following Table 1.

TABLE 1

| | Compound D (g) | BE188 (g) |
|---|---|---|
| Flame retardant epoxy - A | 5 | 95 |
| Flame retardant epoxy - B | 20 | 80 |
| Flame retardant epoxy - C | 50 | 50 |
| Flame retardant epoxy - D | 70 | 30 |
| Flame retardant epoxy - E | 90 | 10 |
| Flame retardant epoxy - F | 95 | 5 |

### EXAMPLE 6

### (Preparation of Flame Retardant Plastics)

15 g of compound A and 100 g of a thermoplastic resin were blended by hot melting to form a flame retardant thermoplastic resin. In this example the blending was carried out by hot melting, which might be carried out by using a solvent. Various thermoplastic resins were used in this example including polycarbonate, polystyrene, acryzonitrile-butadiene-styrene copolymer (ABS), polyphenyloxide (PPO), polyethylene terephthalate (PET), polybutylene terephthalate (PBT).

### EXAMPLE 7

### (Preparation of Phosphorus-Containing Epoxy Resins)

Compound C and a commercially available epoxy resin (BE 188) were mixed in various ratios shown in Table 2. To the mixture 1000 ppm of triphenyl phosphine and 50 ml of methyl ethyl ketone were added. A curing reaction was carried out at 140° C. for 3 hours to form a phosphorus-containing epoxy resin.

| | Compound C (g) | BE 188 (g) |
|---|---|---|
| Phosphorus-containing epoxy resin - 1 | 10 | 50 |
| Phosphorus-containing epoxy resin - 2 | 10 | 40 |
| Phosphorus-containing epoxy resin - 3 | 10 | 30 |
| Phosphorus-containing epoxy resin - 4 | 10 | 20 |

### EXAMPLE 8

### (Synthesis of Flame Retardant Polymer—Polyamide)

8 g of compound C and 4,4-diaminodiphenylmethane (DDM) were mixed in an equal molar ratio. To the mixture, 0.8 g of calcium chloride, 32 ml of triphenyl phosphite, 32 ml of pyridine and 30 ml of N-methylpyrollidone (NMP) were added. The resulting mixture was reacted at 100° C. for 4 hours. The reaction mixture was cooled to room temperature and precipitated with methanol. The precipitate was collected, washed with hot water and methanol, and dried in vacuo at 150° C. for 24 hours to obtain a phosphorus-containing polyamide.

1. A phosphorous-containing compound having the following structure: 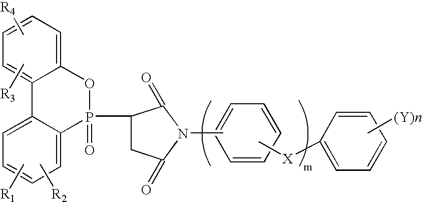
wherein R₁-R₄ independently are H, or C₁-C₄ alkyl; X is a single bond, —CH₂—, —C(CH₃)₂—, 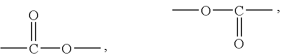
—O—, —S— or —SO₂—; Y is H, C₁-C₄ alkyl, —OH, —NH₂, —NO₂, —COOH, —CHO or 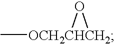
m is an integer of 0-2, and n is an integer of 1-4.

2. The compound as claimed in claim 1, wherein is H.

3. The compound as claimed in claim 1, wherein Y is —OH.

4. The compound as claimed in claim 1, wherein Y is —COOH.

5. The compound as claimed in claim 1, wherein Y is

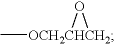

6. The compound as claimed in claim 1, wherein R₁-R₄ are H.

7. The compound as claimed in claim 1, wherein X is a single bond.

8. The compound as claimed in claim 1, wherein X is —CH₂—.

9. The compound as claimed in claim 1, wherein X is —C(CH₃)₂—.

10. The compound as claimed in claim 1, wherein m is 0.

11. A flame retardant resin prepared by blending a phosphorous-containing compound as defined in claim 1 with a resin.

12. A flame retardant resin prepared by reacting the phosphorous-containing compound as defined in claim 1 with a resin or a compound.
